(19) United States
(12) Patent Application Publication
(10) Pub. No.: US 2026/0342271 A1
(43) Pub. Date: Oct. 29, 2026

(54) PHOTOVOLTAIC POWER GENERATION APPARATUS, AND DEVICE AND METHOD FOR MANAGING OPERATION THEREOF

(71) Applicant: HANWHA SOLUTIONS CORPORATION, Seoul (KR)

(72) Inventor: Jin Woo LEE, Seoul (KR)

(21) Appl. No.: 19/651,270

(22) Filed: Apr. 17, 2026

(30) Foreign Application Priority Data
Apr. 29, 2025 (KR) 10-2025-0056411

(51) Int. Cl. H02S 10/20; H02J 3/32; H02J 3/38; H02S 50/00; H02J 101/24; H02J 103/30

(52) U.S. Cl. CPC H02S 10/20; H02J 3/32; H02J 3/381; H02S 50/00; H02J 2101/25; H02J 2103/30

(57) ABSTRACT

Disclosed is a photovoltaic (PV) power generation apparatus, and a device and method for managing operation thereof. According to an embodiment of the present disclosure, the PV power generation apparatus includes: a PV module; a bidirectional power conversion device connected via a power line to the PV module; a battery configured to store power supplied from at least one of the PV module and the bidirectional power conversion device and supply the stored power to the bidirectional power conversion device; and a battery controller connected between a connection point located on the power line and the battery. The bidirectional power conversion device and the battery controller operate based on an operation mode, and the operation mode is determined based on state information including power generation state information of the PV module and battery state information of the battery.

### CROSS-REFERENCE TO RELATED APPLICATION

This application is based on and claims priority under 35 U.S.C. 119 to Korean Patent Application No. 10-2025-0056411, filed on Apr. 29, 2025, in the Korean Intellectual Property Office, the disclosure of which is incorporated by reference herein in its entirety.

### BACKGROUND

### 1. Field

The present disclosure relates to a photovoltaic (PV) power generation apparatus, and a device and method for managing operation thereof.

### 2. Description of the Related Art

With the widespread adoption of power supply systems based on photovoltaic (PV) power generation, a power supply system having a PV module integrated with an energy storage device is gaining significant attention. Such power supply systems can provide a stable power supply by efficiently linking the power generated from PV modules with the grid, and by utilizing batteries to store and supply power according to a load state.

However, with conventional technologies, there may be difficulties in installing energy storage devices occupying a large space indoors, or even if large-capacity energy storage devices are installed, there may be constraints on spatial design during capacity expansion.

Accordingly, there is a demand for technologies that enable efficient spatial design, such as integrating batteries and PV modules or providing compact battery modules, while ensuring a reliable power supply under various load conditions through optimized operational control.

The description in the background is provided for the purpose of helping to understand the present disclosure, and it should not be taken as an admission that the information constitutes prior art that is already known to a person of ordinary skill in the art.

### SUMMARY

The present disclosure provides a photovoltaic (PV) power generation apparatus, and a device and method for managing operation thereof. The objects of the present disclosure are not limited to those mentioned above, and other objects and advantages of the present disclosure not mentioned will be understood from the following description and become more apparent from the embodiments of the present disclosure. In addition, the objects and advantages of the present disclosure may be realized by the means and combinations set forth in the appended claims.

In a first aspect of the present disclosure, there is provided a photovoltaic (PV) power generation apparatus including: a PV module; a bidirectional power conversion device connected via a power line to the PV module; a battery configured to store power supplied from at least one of the PV module and the bidirectional power conversion device and supply the stored power to the bidirectional power conversion device; and a battery controller connected between a connection point located on the power line and the battery, wherein the bidirectional power conversion device and the battery controller operate based on an operation mode, and wherein the operation mode is determined based on state information including power generation state information of the PV module and battery state information of the battery.

According to an embodiment of the present disclosure, the bidirectional power conversion device, the battery, and the battery controller may be provided at a rear side of the PV module.

According to an embodiment of the present disclosure, the operation mode may be determined to be at least one of a plurality of preset modes comprising: a first mode for supplying power from the PV module to the battery, a second mode for supplying power from the PV module to the bidirectional power conversion device, a third mode for supplying power from the battery to the bidirectional power conversion device; and a fourth mode for supplying power from the bidirectional power conversion device to the battery.

According to an embodiment of the present disclosure, based on the operation mode being determined to include the second mode and the third mode, the battery controller may output current to the bidirectional power conversion device with one-side voltage being set to a voltage of the battery and the other-side voltage being set to a voltage of the PV module, and based on the operation mode determined to exclude the second mode and include the third mode, the battery controller may output current to the bidirectional power conversion device with the one-side voltage being set to a voltage of the battery and the other-side voltage being set to a predetermined voltage.

According to an embodiment of the present disclosure, a voltage of the PV module may correspond to an operating point determined by the bidirectional power conversion device based on a maximum power point tracking (MPPT) algorithm.

According to an embodiment of the present disclosure, the bidirectional power conversion device may operate based on first operation data obtained from a management device, the battery controller may operate based on second operation data generated based on an operation mode and obtained from the bidirectional power conversion device , and the management device may determine the operation mode and generates the first operation data based on the operation mode.

According to an embodiment of the present disclosure, the battery controller may transmit the battery state information to the bidirectional power conversion device, and the bidirectional power conversion device may transmit the power generation state information and the battery state information to the management device.

According to an embodiment of the present disclosure, the management device may obtain, from a plurality of bidirectional power conversion devices comprising the bidirectional power conversion device, state information corresponding to each of the plurality of bidirectional power conversion devices, and may determine an operation mode corresponding to each of the plurality of bidirectional power conversion devices based on the state information.

According to an embodiment of the present disclosure, the state information may further comprise at least one of: a time; a weather condition; a load state of a load connected to the bidirectional power conversion device; and a power grid state of a grid connected to the bidirectional power conversion device.

According to an embodiment of the present disclosure, the PV power generation apparatus may further include a current direction control element provided between the PV module and the connecting point and configured to limit current flowing toward the PV module.

In a second aspect of the present disclosure, there is provided a device for managing operation of a photovoltaic (PV) power generation apparatus, including: a communication unit configured to perform communication; a memory having at least one program stored therein; and a processor configured to operate by executing at least one program, wherein the processor controls the communication unit to obtain state information from a bidirectional power conversion device corresponding to each of at least one PV power generation apparatus, and determines an operation mode corresponding to each of the at least one PV power generation apparatus based on the state information.

According to an embodiment of the present disclosure, each of the at least one PV power generation apparatus may include: a bidirectional power conversion device; a PV module connected via a power line to the bidirectional power conversion device; a battery configured to store power supplied from at least one of the PV module and the bidirectional power conversion device and supply the stored power to the bidirectional power conversion device; and a battery controller connected between a connection point located on the power line and the battery, and the bidirectional power conversion device and the battery controller operate based on the operation mode.

According to an embodiment of the present disclosure, the state information may include power generation state information of the PV module and battery state information of the battery.

According to an embodiment of the present disclosure, the processor may control the communication module to obtain the power generation state information and the battery state information from the bidirectional power conversion device, and the battery state information may be obtained by the bidirectional power conversion device from the battery controller.

According to an embodiment of the present disclosure, the state information may further include at least one of: a time; a weather condition; a load state of a load connected to the bidirectional power conversion device; and a power grid state of a grid connected to the bidirectional power conversion device.

According to an embodiment of the present disclosure, the processor may determine the operation mode to be at least one of a plurality of preset modes comprising: a first mode for supplying power from the PV module to the battery, a second mode for supplying power from the PV module to the bidirectional power conversion device, a third mode for supplying power from the battery to the bidirectional power conversion device; and a fourth mode for supplying power from the bidirectional power conversion device to the battery.

According to an embodiment of the present disclosure, the processor may generate first operation data based on the operation mode and control the communication unit to transmit the first operation data to the bidirectional power conversion device, the bidirectional power conversion device may operate based on the first operation data and transmits second operation data generated based on the operation mode to the battery controller, and the battery controller may operate based on the second operation data.

In a third aspect of the present disclosure, there is provided a method for managing operation of a photovoltaic (PV) power generation apparatus, including obtaining state information from a bidirectional power conversion device corresponding to each of at least one PV power generation apparatus; and determining an operation mode corresponding to each of the at least one PV power generation apparatus based on the state information.

Other aspects, advantages, and salient features of the disclosure will become apparent to those skilled in the art from the accompanying drawings, claims, and detailed description of the present disclosure.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is an exemplary drawing illustrating a power supply system.

FIG. 2 is an exemplary drawing schematically illustrating a photovoltaic (PV) power generation apparatus according to an embodiment.

FIG. 3 is an exemplary drawing illustrating a bidirectional power conversion device, a battery, and a battery controller provided at a rear side of a PV module according to an embodiment.

FIG. 4 is an exemplary drawing illustrating a battery module according to an embodiment.

FIG. 5 is an exemplary drawing illustrating a plurality of batteries connected in parallel according to an embodiment.

FIG. 6 is an exemplary drawing illustrating an operation mode according to an embodiment.

FIG. 7 is an exemplary drawing illustrating a management device that determines an operation mode according to an embodiment.

FIG. 8 is an exemplary drawing illustrating a procedure of performing communication between a management device, a bidirectional power conversion device, and a battery controller according to an embodiment.

FIG. 9 shows an example of an operation method of a management device.

FIG. 10 is an example of a procedure of determining an operation mode according to an embodiment.

FIG. 11 is an example of a procedure of determining an operation mode according to another embodiment.

FIG. 12 is a block diagram illustrating a management devices according to an embodiment.

### DETAILED DESCRIPTION

Advantages and features of the present disclosure and methods for achieving the same will become apparent from the following description of embodiments, taken in conjunction with the accompanying drawings. However, it should be understood that the present disclosure is not limited to the embodiments disclosed below, but may be implemented in various other forms. To this end, the present disclosure encompasses all modifications, equivalents, and substitutes falling within the spirit and scope of the present disclosure. These embodiments are provided so that this disclosure will be thorough and complete, and will fully convey the scope of the present disclosure to those skilled in the art. In describing the present disclosure, detailed descriptions of related well-known technologies will be omitted when it is determined that they may obscure the gist of the present disclosure.

The terms used in the present specification are used to describe specific embodiments only and are not intended to limit the present disclosure. Unless otherwise defined, all terms used herein have the same meanings as those commonly understood by one of ordinary skill in the art to which the present disclosure belongs.

In the present specification, singular forms are intended to include plural forms as well, unless the context clearly indicates otherwise. Further, the terms “include,” “comprise,” or “have” should be understood to designate the presence of stated features, numbers, steps, operations, components, parts, or combinations thereof, and do not preclude the presence or addition of one or more other features, numbers, steps, operations, components, parts, or combinations thereof.

Further, ordinal terms such as “first” or “second” used herein may be used to describe various components, but the components should not be limited by these terms. These terms are used only for the purpose of distinguishing one component from another.

Phrases such as “in an embodiment,” “according to an embodiment,” “in connection with an embodiment,” or the like in this specification do not necessarily all refer to the same embodiment. Further, throughout the specification, an “embodiment” is an arbitrary division for the purpose of describing the present disclosure, and the respective embodiments are not necessarily mutually exclusive. For example, configurations described in one embodiment may be applied to and implemented in other embodiments, and may be modified and implemented without departing from the spirit and scope of the present disclosure.

Embodiments of the present disclosure may be described in terms of functional block configurations and various processing operations. Some or all of these functional blocks may be implemented by various hardware and/or software configurations configured to perform specific functions. For example, the functional blocks may be implemented by one or more microprocessors or by circuit configurations for a specific function.

For example, the functional blocks of the present disclosure may be implemented in various programming or scripting languages. Such functional blocks may be implemented by algorithms executed by one or more processors. In addition, the present disclosure may employ conventional techniques for electronic configuration, signal processing, and/or data processing. Terms such as “mechanism,” “element,” “means,” and “configuration” are used broadly and are not limited to mechanical or physical configurations. Further, terms such as “-unit,” “-module,” or the like refer to a unit for processing at least one function or operation, which may be implemented in hardware, software, or a combination thereof.

Further, connection lines or connection members between components shown in the drawings are exemplary of functional connections and/or physical or circuit connections. In a practical device, connections between components may be represented by various functional, physical, or circuit connections that may be replaced or added.

In addition, some components in the drawings may be exaggerated in size or proportion for clarity. Further, components shown in one drawing may be omitted in other drawings.

Hereinafter, the present disclosure will be described in detail with reference to the accompanying drawings.

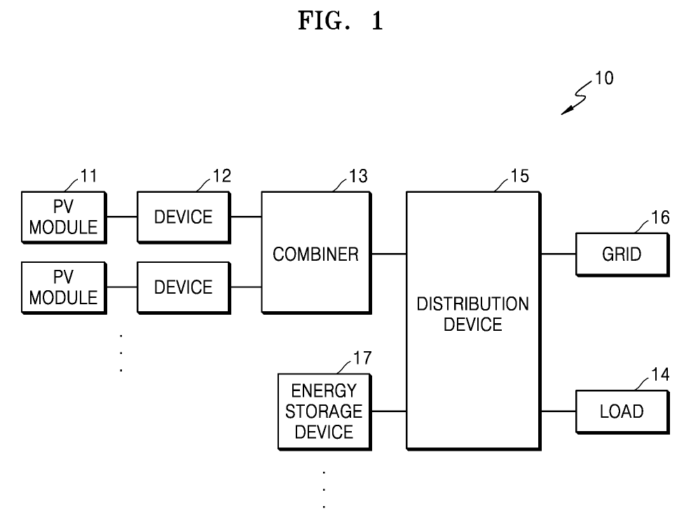

FIG. 1 is an exemplary drawing schematically illustrating a power supply system.

Referring to FIG. 1, a power supply system 10 may include a photovoltaic (PV) module 11, a device 12, a load 14, and/or a distribution device 15. The power supply system 10 may be connected to an external grid 16.

At least one PV module 11 may be installed at a roof or exterior wall of a building to generate electricity. A plurality of PV modules 11 may be connected to form a PV module array.

The PV module 11 may be connected to the device 12. For example, each PV module 11 may be connected to at least one device 12. As an example, when each PV module 11 is connected to a single device 12, the number of devices 12 included in the power supply system 10 may be equal to the number of PV modules 11.

The device 12 may be a Power Conditioning System (PCS) or Power Conversion System (PCS) configured to perform conversion on power generated by the PV module 11. For example, the device 12 may perform predetermined conversion on the power generated by the PV module 11 and provide the converted power to another component of the power supply system 10 (e.g., the grid 16 and the load 14).

In addition, the device 12 may be a module level power electronic (MLPE). For example, the device 12 may be an optimizer or a micro inverter (MI).

As an example, when the device 12 is an optimizer, the device 12 may regulate power produced by the PV module 11 and output the regulated power to an inverter (e.g., a string inverter). Current converted by the inverter (e.g., converting direct current (DC) to alternating current (AC)) may be output to the grid 16 or the load 14.

As another example, when the device 12 is a micro-inverter, the device 12 may convert power generated in the PV module 11 (e.g., converting direct current (DC) to alternating current (AC)). The current converted by the device 12 may be output to the grid 16 or the load 14.

If necessary, the power supply system 10 may further include a combiner 13. At least one device 12 may be connected to the distribution device 15 through the combiner 13. For example, power output from a plurality of devices 12 may be combined by the combiner 13 and supplied to the distribution device 15.

On the other hand, the device 12 and the distribution device 15 may be connected via a power path not including the combiner 13, at least one device 12 may be connected to the distribution device 15 via the power path not including the combiner 13, and at least one other device 12 may be connected to the distribution device 15 through the combiner 13.

The combiner 13 may perform control over voltage, current and/or power output from the device 12 depending on a power supply state of the PV module 11, the device 12 and/or the grid 16, and an operation mode of the combiner 13 may be set to a diagnostic mode, an operational mode, or the like.

In addition, the combiner 13 may include an energy management system (EMS) configured to control the operation of the combiner 13. The EMS may perform control over voltage, current, and/or power supplied to or output from the combiner 13, depending on a power supply state of the PV module 11, the device 12, and/or the grid 16, and the operation mode of the combiner 13 may be set to a diagnostic mode, an operational mode, or the like.

The load 14 refers to an object that is installed in an electricity consumer, such as a residential facility, a commercial facility, and a factory, to operate by receiving at least one of energy generated by a PV module 11, energy stored in an energy storage device 17, and/or energy supplied from the grid 16. For example, when the electricity consumer is a household, the load 14 may include a home appliance such as a washing machine, refrigerator, and TV.

The grid 16 may include an infrastructure system for generating, transmitting, and distributing power. For example, the grid 16 may include an infrastructure system such as a power plant, a substation, and a grid. On the other hand, the grid 16 may transfer electrical energy generated by the power plant to the power supply system 10, or transfer surplus power generated by the power supply system 10 to the outside of the power supply system 10.

For example, commercial power distributed from the grid 16 via utility poles may be supplied to the electricity consumer via a transformer. On the other hand, the power supply system 10 may be implemented as an off-grid system that is not connected to the grid 16.

On the other hand, the power supply system 10 may further include at least one energy storage device 17. If necessary, the power supply system 10 may include a plurality of energy storage devices 17. The energy storage device 17 may receive and store power generated by the PV module 11 and/or power transmitted from the grid 16 . The energy storage device 17 may store power and supply the stored power to the load 14 when the load 14 requires power, thereby facilitating an efficiently power supply.

The energy storage device 17 may include a battery for storing power, and a power conversion module. The battery may be provided with a battery management system (BMS) configured to monitor the battery's state of charge (SOC), state of health (SOH), voltage, and/or current, perform diagnostics on the battery, and perform a safety function such as current interruption.

In addition, the power conversion module may be a power conversion system (PCS) that performs conversion between power on a battery side and power on the opposite side. For example, the PCS may perform conversion between a DC current on a battery side and an AC current on the opposite side. As an example, the PCS may include a bidirectional DC-DC converter connected to the battery to convert a voltage, and a bidirectional inverter configured to connect a DC-DC converter to an outside of the energy storage device 17.

In addition, the energy storage device 17 may further include an energy management system (EMS) configured to control the operation of the energy storage device 17. Depending on a power supply state of the battery and/or the grid 16, the EMS may perform control over voltage, current, and/or power supplied to or from the energy storage device 17, and the operation mode of the energy storage device 17 may be set to a diagnostic mode, an operational mode, or the like.

If necessary, an EMS coupled to a predetermined component of the power supply system 10 may not only control the operation of the predetermined component, but also further control the operation of other components of the power supply system 10. For example, an EMS coupled to the combiner 13 or an EMS coupled to the energy storage device 17 may control both the operation of the combiner 13 and the operation of the energy storage device 17.

On the other hand, the distribution device 15 may provide electrical connection between the components of the power supply system 10 and control a power flow of the power supply system 10. For example, the distribution device 15 may electrically connect the PV module 11 and the load 14. As an example, the distribution device 15 may be connected to the device 12 connected to the PV module 11 to electrically connect the PV module 11 and the load 14. If necessary, the distribution device 15 may be further connected to at least one of the energy storage device 17 and the grid 16.

For example, the distribution device 15 may be a distribution board configured to distribute power within the power supply system 10. As an example, the distribution device 15 may be a main service panel (MSP) that distributes power generated by the PV module 11 to the load 14 or the like.

For another example, the distribution device 15 may be a main controller configured to perform power distribution within the power supply system and control each device 12. As an example, the main controller may include a switch, a circuit breaker, and a control unit. The switch, the circuit breaker, and the control unit may each be implemented as an independent device, or at least one of the switch, the circuit breaker, and the control unit may be included in another one thereof.

The main controller may include a switch configured to control electrical connection between components connected to the main controller, such as the device 12 and the load 14. For example, the main controller may include a relay, a power semiconductor, and the like that provides or disconnects electrical connection to the device 12 and/or the energy storage device 17 depending on an operating state of each component of the power supply system 10.

The main controller may perform a rapid shutdown to stop power generation of the PV module 11 upon occurrence of an emergency, such as over-current in the power supply system 10. To this end, the main controller may include a circuit breaker configured to break connection between the device 12 and the load 14.

The main controller may include a control unit configured to control the overall operation of the main controller. In addition to the main controller, the control unit may control the operation of other components of the power supply system 10 (e.g., the device 12, the energy storage device 17, etc.).

Depending on a power supply state of the PV module 11, the device 12, the combiner 13, the load 14, the grid 16, and/or the energy storage device 17, the control unit may perform control over voltage, current, and/or power output from or supplied to each of the aforementioned components. In addition, the control unit may set the operation mode of the main controller, the device 12 and/or the energy storage device 17 to a diagnostic mode, an operational mode, or the like.

For example, the control unit may control the PV module 11, the device 12, the combiner 13, and/or the energy storage device 17 based on a state of the power supply system 10. As an example, the control unit may control other components of the power supply system 10 by allowing the main controller to communicate with other components of the power supply system (e.g., the device 12, etc.). Communication between the main controller and other components of the power supply system 10 may be performed in the form of power line communication (PLC), but the present disclosure is not limited thereto.

As an example, the control unit may control the device 12 according to power generation state information of the PV module 11. For example, the main controller may receive a control command from a server for monitoring power generation state information of the PV module 11, and the control unit may control the device 12 in accordance with the control command.

The main controller may provide power to at least one load 14 when power supply from the grid 16 is not stable (e.g., an off-grid condition, etc.). For example, when power supply from the grid 16 is not stable, the main controller may preferentially supply power generated by the PV module 11 and/or power stored in the energy storage device 17 to a backup load with a relatively high requirement for stable power supply.

On the other hand, the power supply system 10 may further include an auxiliary power generator (e.g., a diesel generator, etc.) configured to generate electricity through a method other than PV power generation. For example, the distribution device 15 may have an auxiliary power generator connected thereto. The main controller may supply power generated by the auxiliary power generator to the backup load when the PV module 11 and the energy storage device 17 alone cannot meet backup load demand due to an environmental factor such as a time of day, a weather condition, or the like.

The control unit may be implemented by at least one processor. By performing basic arithmetic, logical, and input/output (I/O) operations, the processor may process a command from a computer program. Here, the command may be provided from an internal memory of the main controller or from an external device. In addition, the processor may control the overall operation of other components included in the main controller.

On the other hand, the processor may perform at least one of data analysis, data processing, and generating of result information to perform the above-described operations using at least one rule-based or artificial intelligence algorithm such as a machine learning algorithm, a neural network algorithm, or a deep learning algorithm. Examples of a neural network may include an architecture-based neural network model, such as convolutional neural network (CNN), deep neural network (DNN), and recurrent neural network (RNN).

For example, the processor may be implemented as an array of multiple logic gates, or a combination of a general-purpose microprocessor and a memory in which a program executable on the microprocessor is stored. For example, the processor may include a general-purpose processor, a central processing unit (CPU), a microprocessor, a digital signal processor (DSP), a controller, a micro-controller, a state machine, and the like.

In some environments, the processor may include a custom semiconductor (ASIC), a programmable logic device (PLD), a field programmable gate array (FPGA), and the like. For example, a processor may refer to a combination of processing devices, such as a combination of a digital signal processor (DSP) and a microprocessor, a combination of multiple microprocessors, a combination of one or more microprocessors combined with a digital signal processor (DSP) core, or any other combination of such configurations.

By combining at least a portion of the above-described components, the power supply system 10 may be implemented in various forms. For example, the power supply system 10 may not include an energy storage device 17 connected to the distribution device 15 and may include a plurality of energy storage devices 17 connected to the distribution device 15.

Further, for example, the power supply system 10 may include the distribution device 15 implemented as a single device, and the distribution device 15 implemented as a plurality of devices such as a main controller, at least one distribution board, and/or at least one sub-panel.

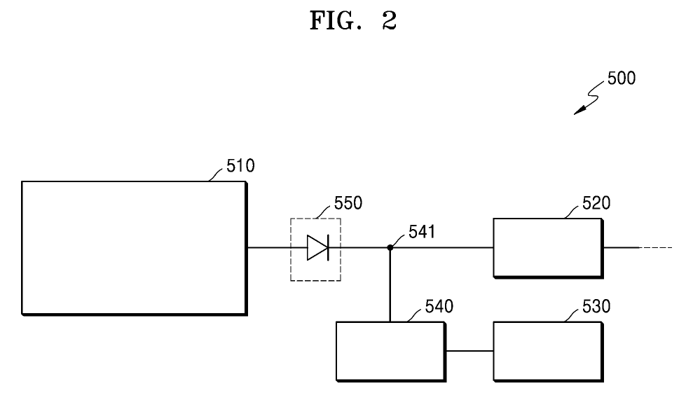

FIG. 2 is an exemplary drawing schematically illustrating a photovoltaic (PV) power generation apparatus according to an embodiment.

Referring to FIG. 2, a PV power generation apparatus 500 may include a PV module 510 and a bidirectional power conversion device 520. The PV module 510 shown in FIG. 2 may represent the PV module 11 described above with reference to FIG. 1, and the bidirectional power conversion device 520 shown in FIG. 2 may be understood as an example of the device 12 described above with reference to FIG. 1.

In an embodiment, the bidirectional power conversion device 520 may supply power from the PV power generation apparatus 500 to the outside of the PV power generation apparatus 500, and vice versa. In other words, the bidirectional power conversion device 520 may perform conversion between power from the PV module 510 and power of the opposite side.

For example, the bidirectional power conversion device 520 may be connected to the PV module 510 via a power line to perform conversion between DC of the PV power generation apparatus 500 and current of the opposite side. In this case, the current of the opposite side may be DC or AC according to the design, and in either case, the bidirectional power conversion device 520 may include a bidirectional converter configured to perform DC-DC conversion or a bidirectional inverter configured to perform AC-DC conversion.

As an example, the bidirectional power conversion device 520 may be provided between the PV module 510 and the distribution device 15 described above with reference to FIG. 1 to perform power conversion in both directions. In this case, the combiner 13 described above with reference to FIG. 1 may be further provided between the bidirectional power conversion device 520 and the distribution device 15.

In an embodiment, the PV power generation apparatus 500 may further include a battery 530. The battery 530 may include any type of battery that stores and supplies electrical energy through physical and chemical action.

For example, the battery 530 may store power supplied from at least one of the PV module 510 and the bidirectional power conversion device 520, and supply the stored power to the bidirectional power conversion device 520. In an embodiment, the battery 530 may include a secondary battery capable of being charged and discharged as needed, and may include, but is not limited to, a lithium-ion battery.

As an example, the battery 530 may receive power from the PV module 510, from the bidirectional power conversion device 520, or from both the PV module 510 and the bidirectional power conversion device 520, and store the received power therein. In addition, the battery 530 may supply the stored power to the bidirectional power conversion device 520.

In other words, the battery 530 may be connected with the bidirectional power conversion device 520, so that the battery 530 can be charged through the bidirectional power conversion device 520 even if sufficient power is not received from the PV module 510 due to time or weather conditions.

In an embodiment, the PV power generation apparatus 500 may further include a battery controller 540. In this disclosure, the battery controller 540 refers to a controller connected to the battery 530 to control charging and discharging of the battery 530.

In an embodiment, the battery controller 540 may be connected between the battery 530 and a connection point 541 on a power line that connects the PV module 510 and the bidirectional power conversion device 520. That is, the battery controller 540 may be connected to each of the battery 530 and the connection point 541 located on a DC link between the PV module 510 and the bidirectional power conversion device 520. In this case, the battery controller 540 may be connected to the PV module 510 and the bidirectional power conversion device 520 via the connection point 541.

The battery controller 540 may control voltages of both ends and/or an output current thereof in order to control charging and discharging of the battery 530. In this case, controlling the output current of the battery controller 540 may include controlling the magnitude and direction of the current output from the battery controller 540.

In an embodiment, the battery controller 540 may include a bidirectional converter configured to perform DC-DC conversion. This allows the battery controller 540 to perform power conversion between the connection point 541 on the DC link and the battery 530, thereby controlling the charging and discharging of the battery 530.

In an embodiment, in order to control the voltages of both ends thereof, the battery controller 540 may include a bidirectional buck-boost converter capable of operating in either a buck mode or a boost mode. For example, the battery controller 540 may control charging and discharging of the battery 530 by stepping up a relatively low voltage at the battery 530 to a relatively high voltage at the connection point 541, or by stepping down a relatively high voltage at the connection point 541 to a relatively low voltage at the battery 530.

On the other hand, depending on the design, the voltage at the battery 530 may be higher than a voltage at the connection point 541, and depending on power generation state information of the PV module 510, the voltage at the connection point 541 may not be fixed to be higher or lower than the voltage at the battery 530.

In addition, the battery controller 540 may control the voltages of both ends thereof as an output voltage of the battery 530 and an output voltage of the PV module 510, but at least one of the voltages of both ends of the battery controller 540 may be controlled as a set fixed value.

In an embodiment, the battery controller 540 may further include a battery management system (BMS) configured to manage battery state information of the battery 530. In this case, the BMS may collect and/or generate the battery state information of the battery 530 via at least one sensor (e.g., a current sensor, a voltage sensor, a temperature sensor, etc.) connected to the BMS.

In addition, the BMS may perform safety control for the battery 530. For example, the BMS may detect over-current, over-voltage, short-circuit, and/or high-temperature, and limit the charging and discharging of the battery 530.

In an embodiment, the battery 530 may not be provided separately from the PV module 510 indoors in a building, but may be coupled to the PV module 510. In this case, the BMS may detect a temperature of the battery 530 and limit the charging and discharging of the battery 530 based on the temperature of the battery 530 exceeding a predetermined threshold temperature. This ensures safe charging and discharging the battery 530 even when the battery 530 is coupled to the PV module 510.

In an embodiment, the bidirectional power conversion device 520 and the battery controller 540 may operate based on a determined operation mode. In the present disclosure, the operation mode refers to a manner in which the PV power generation apparatus 500 operates. In an embodiment, the operation mode may indicate whether power is supplied and a direction of the power supply.

For example, the operation mode may indicate that power is supplied from the PV power generation apparatus 500 to an outside of the PV power generation apparatus 500, or vice versa. In addition, for example, when power is supplied from the PV power generation apparatus 500 to the outside of the PV power generation apparatus 500, the operation mode may indicate an entity that supplies power to the outside of the PV power generation apparatus 500 among the PV module 510 and battery 530.

In this case, the bidirectional power conversion device 520 and the battery controller 540 may or may not supply power in a predetermined direction depending on the determined operation mode. For example, when the operation mode indicates that power is supplied from the PV power generation apparatus 500 to the outside and that both the PV module 510 and battery 530 are the sources of power supply, the bidirectional power conversion device 520 may operate to output a current from the connection point 541 to an outside of the PV power generation apparatus 500, and the battery controller 540 may operate to output a current from the battery 530 to the connection point 541.

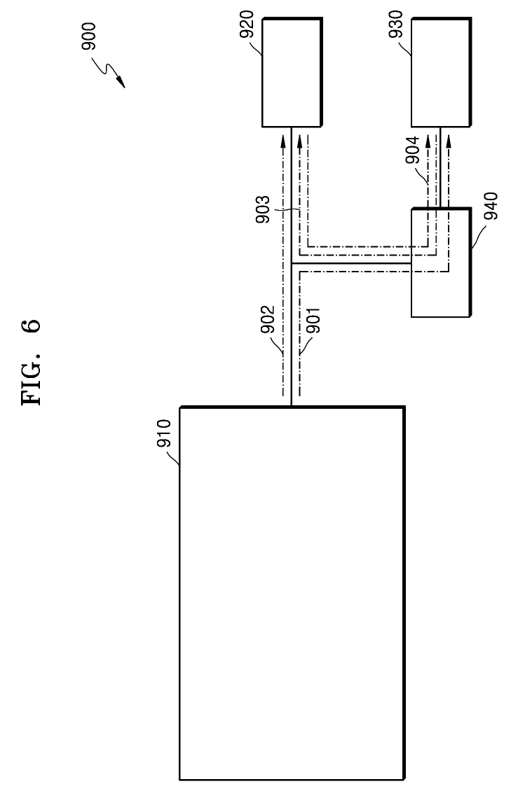

Meanwhile, the operation mode may be determined to include at least one mode among a plurality of preset modes. Detailed examples of the plurality of preset modes will be described with reference to FIG. 6.

In an embodiment, the operation mode may be determined based on state information. In the present disclosure, the state information refers to information on a state of at least a portion of a power supply system including the PV power generation apparatus 500. For example, the state information may include power generation state information of the PV module 510 and/or battery state information of the battery 530.

As an example, the power generation state information of the PV module 510 may include an output current, a voltage, and the like, which are generated from the PV module 510. In addition, as an example, the battery state information of the battery 530 may include charge state information of the battery 530, such as a State of Charge (SoC) and a State of Health (SoH), and may further include an output current, a voltage, a temperature, and the like of the battery 530.

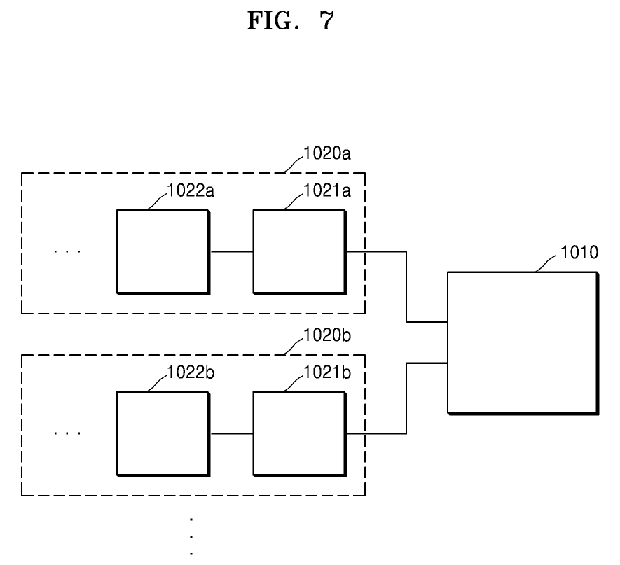

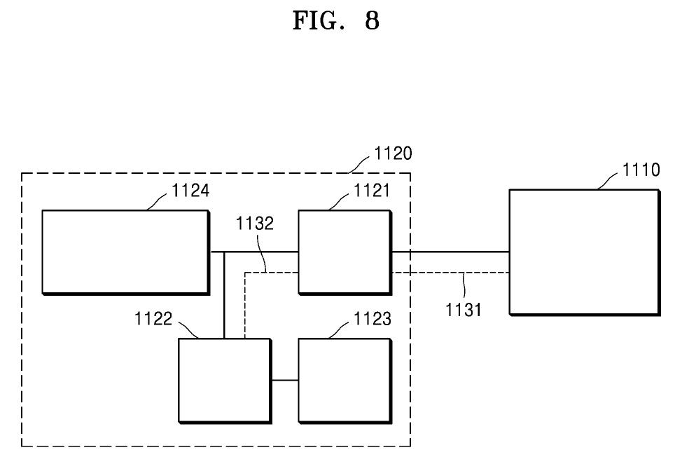

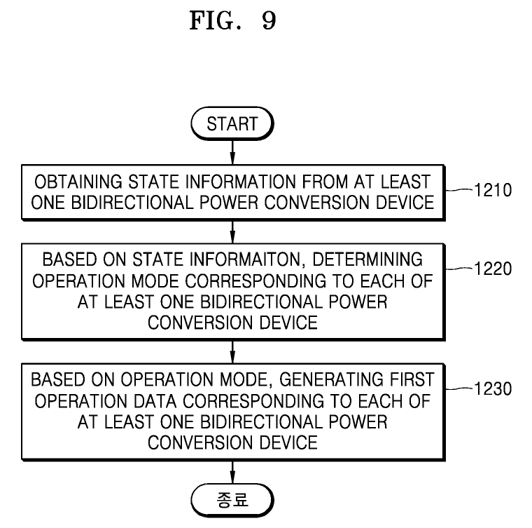

In an embodiment, the operation mode may be determined by a management device configured to perform management of at least a portion of the power supply system. Meanwhile, detailed examples of implementation of the management device will be described with reference to FIGS. 7-8, and a detailed example of a procedure of determining an operation mode by a management device will be described with reference to FIGS. 9-11.

In an embodiment, the PV power generation apparatus 500 may further include a current direction control element 550. For example, the current direction control element 550 may be provided between the PV module 510 and the connection point 541 to limit a current flowing toward the PV module 510.

That is, the current direction control element 550 may allow current flowing from the PV module 510 to the connection point 541 to pass therethrough, and may block current flowing from the connection point 541 to the PV module 510.

For example, the current direction control element 550 may be implemented to include at least one diode element. As an example, the current direction control element 550 may be implemented as a single diode element or a plurality of diode elements connected in series. As another example, the current direction control element 550 may be implemented as an ideal diode element that includes a body diode and a MOSFET connected in parallel.

As the PV power generation apparatus 500 includes the current direction control element 550 installed between the PV module 510 and the connection point 541, the current output from the battery 530 or the bidirectional power conversion device 520 may be prevented from flowing toward the PV module 510. This ensures a stable power supply from the battery 530 to the bidirectional power conversion device 520, or a stable power supply from the bidirectional power conversion device 520 to the battery 530.

Specifically, when reverse current flows toward the PV module 510, a cell and/or circuit within the PV module 510 may be damaged, so the PV power generation apparatus 500 includes the current direction control element 550 to prevent reverse current.

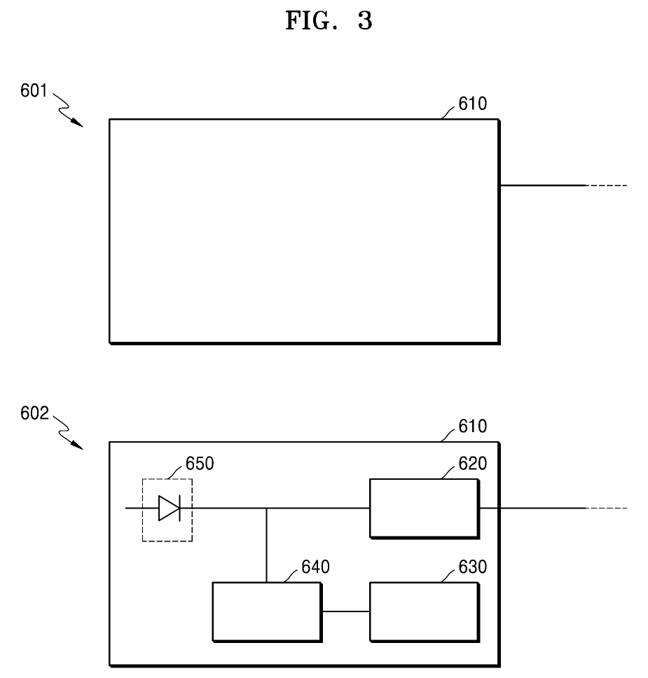

FIG. 3 is an exemplary drawing illustrating a bidirectional power conversion device, a battery, and a battery controller provided at a rear side of a PV module according to an embodiment. A front side 601 and a rear side 602 shown in FIG. 3 are exemplary front and rear sides of a PV module 610 in practice, respectively.

For example, in practice, the PV module 610 may be installed at a roof of a building such as a house, a rooftop, or the like. In this case, the front side 601 of the PV module 610 represents a side where the PV module 610 is exposed to the light source to generate power. On the other hand, the rear side 602 represents a side not intended to be directly exposed to a light source.

Referring to FIG. 3, a bidirectional power conversion device 620, a battery 630, and a battery controller 640 may be provided at the rear side 602 of the PV module 610. In addition, a current direction control element 650 may be provided at the rear side 602 of the PV module 610, along with the bidirectional power conversion device 620, the battery 630, and the battery controller 640.

In an embodiment, the bidirectional power conversion device 620, the battery 630, and the battery controller 640 may each be provided in compact size not to be visible on the front side 601 of the PV module 610 and may be provided at the rear side 602 of the PV module 610.

In this case, the bidirectional power conversion device 620 may connect a single PV module 610 to the outside of a PV power generation apparatus. In addition, the battery 630 and the battery controller 640 may be connected between the PV module 610 and the bidirectional power conversion device 620 to correspond to a single PV module 610.

For example, a power supply system may include a plurality of PV modules 610 and a plurality of bidirectional power conversion devices 620. Here, each of the plurality of PV modules 610 may correspond to one of the plurality of bidirectional power conversion devices 620. As an example, a bidirectional power conversion device 620 may be a power conversion device (e.g., a micro inverter, etc.) designed to satisfy the ratings of a single PV module 610, not a power conversion device designed to satisfy the ratings of the plurality of PV modules 610.

In addition, the power supply system may include a plurality of PV modules 610, each of which is provided with a compact bidirectional power conversion device 620, a compact battery 630, and a compact battery controller 640. In this case, even if a relatively large energy storage device is not provided in the power supply system, a plurality of compact batteries 630 may store power and supply the stored power to a load when the load requires power, thereby facilitating efficient power supply. For example, at least one of the plurality of compact batteries 630 may provide stable power supply to the load such as a backup load, even in an off-grid environment.

This allows an energy storage device with a relatively large volume to be replaced by the plurality of compact batteries 630 and provides a power supply system capable of efficient space design.

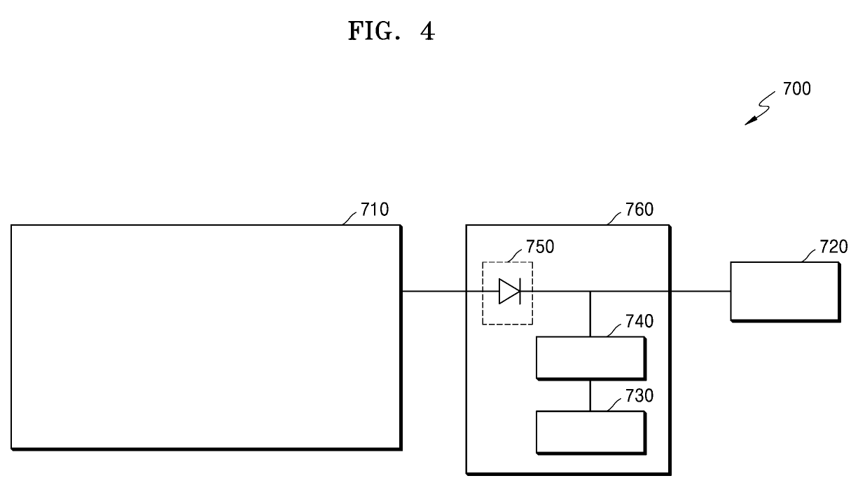

FIG. 4 is an exemplary drawing illustrating a battery module according to an embodiment.

In an embodiment, at least one of a bidirectional power conversion device 720, a battery 730, a battery controller 740, and a current direction control element 750, each of which is connected to a PV module 710, may be accommodated within a single housing. For example, at least one of the bidirectional power conversion device 720, the battery 730, the battery controller 740, and the current direction control element 750 may be implemented as a single integrated product.

Referring to FIG. 4, a PV power generation apparatus 700 may include at least one battery module 760. In an embodiment, the battery 730 and the battery controller 740 may implement a single battery module 760. For example, the battery 730 and battery controller 740 may be accommodated within a single housing to implement the single battery module 760. The battery module 760 may be provided between the PV module 710 and the bidirectional power conversion device 720, and the connection point 541 shown in FIG. 2 may be located within the battery module 760.

The battery module 760 including the battery 730 and the battery controller 740 is provided. Accordingly, by providing the battery module 760 alone between the PV module 710 and the bidirectional power conversion device 720 such as a conventional micro inverter, it is possible to implement the PV power generation apparatus 700 including the battery 730. In doing so, the PV power generation apparatus 700 including the battery 730 may be provided with minimal design modifications.

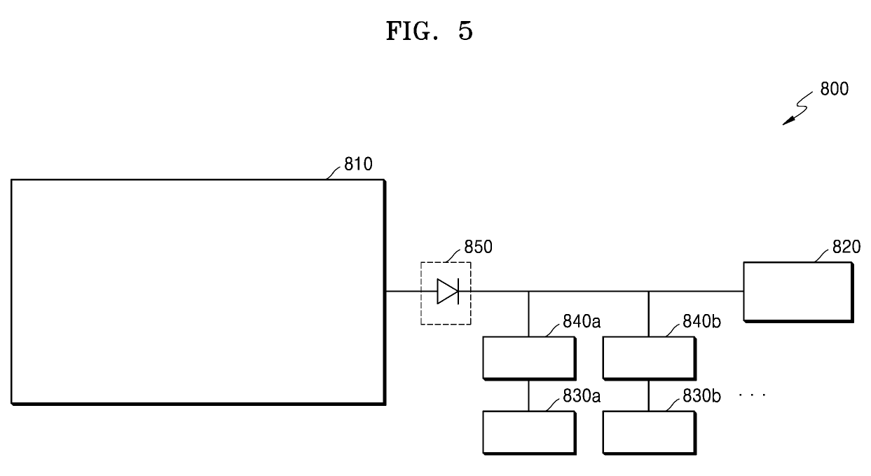

FIG. 5 is an exemplary drawing illustrating a plurality of batteries connected in parallel according to an embodiment.

Referring to FIG. 5, a PV power generation apparatus 800 may include a plurality of batteries 830a and 830b and at least one battery controller 840a or 840b. In an embodiment, the PV power generation apparatus 800 may include the plurality of batteries 830a and 830b and the at least one battery controller 840a or 840b, each of which is connected in parallel to a power line connecting a PV module 810 and a bidirectional power conversion device 820.

Hereinafter, for the convenience of explanation, it is assumed that the PV power generation apparatus 800 includes two batteries. However, the PV power generation apparatus 800 may include three or more batteries.

In an embodiment, a first battery 830a may be connected to a first connection point located on a power line connecting the PV module 810 and the bidirectional power conversion device 820 via the first battery controller 840a, and a second battery 830b may be connected to a second connection point located on a power line connecting the PV module 810 and the bidirectional power conversion device 820 via the second battery controller 840b. In this case, the charging and discharging of the first battery 830a may be controlled by the first battery controller 840a, and the charging and discharging of the second battery 830b may be controlled by the second battery controller 840b.

In addition, a pair of the first battery 830a and the first battery controller 840a and a pair of the second battery 830b and second battery controller 840b may be implemented as a first battery module and a second battery module, respectively. Here, each of the first battery module and the second battery module may be implemented as the battery module 760 described above with reference to FIG. 4.

On the other hand, when the plurality of batteries 830a and 830b are connected to a power line, which connects the PV module 810 and the bidirectional power conversion device 820, via a plurality of connection points, a current direction control element 850 may be provided between the PV module 810 and a connection point closest to the PV module 810. In doing so, the plurality of batteries 830a and 830b may receive power from the bidirectional power conversion device 820 from an external grid and the like and store the received power.

In another embodiment, unlike the example shown in FIG. 5, the first battery 830a and the second battery 830b may be connected via a single battery controller to a single connection point located on a power line connecting the PV module 810 and the bidirectional power conversion device 820. For example, each of the first battery 830a and the second battery 830b may be connected in parallel to the battery controller. In doing so, the battery controller may control charging and discharging of each of the first battery 830a and the second battery 830b.

Thus, a battery capacity of each PV power generation apparatus 800 may be expanded, and each PV power generation apparatus 800 may have an optimized battery capacity for a stable power supply.

FIG. 6 is an exemplary drawing illustrating an operation mode according to an embodiment.

Referring to FIG. 6, in a PV power generation apparatus 900 including a PV module 910, a bidirectional power conversion device 920, a battery 930, and a battery controller 940, a direction of current occurring according to an operation mode is shown. In an embodiment, the direction of the current occurring in the PV power generation apparatus 900 may include at least one of a first direction 901, a second direction 902, a third direction 903, or a fourth direction 904.

In an embodiment, the operation mode may include a first mode for supplying power from the PV module 910 to the battery 930. In this case, the power supply may be performed through the battery controller 940, and the current may flow in the first direction 901.

That is, the first mode may refer to a mode for charging the battery 930 using at least a portion of power generated by the PV module 910.

In an embodiment, the operation mode may include a second mode for supplying power from the PV module 910 to the bidirectional power conversion device 920. In this case, current may flow in the second direction 902.

That is, the second mode may refer to a mode for supplying at least a portion of power generated by the PV module 910 to the outside of the PV power generation apparatus 900 through the bidirectional power conversion device 920.

In an embodiment, the operation mode may include a third mode for supplying power from the battery 930 to the bidirectional power conversion device 920. In this case, the power supply may be performed through the battery controller 940, and current may flow in the third direction 903.

That is, the third mode may refer to a mode for supplying charged power stored in the battery 930 to the outside of the PV power generation apparatus 900 through the bidirectional power conversion device 920.

In an embodiment, the operation mode may include a fourth mode for supplying power from the bidirectional power conversion device 920 to the battery 930. In this case, the power supply may be performed through the battery controller 940, and current may flow in the fourth direction 904.

That is, the fourth mode may refer to a mode for charging the battery 930 using power supplied from the outside of the PV power generation apparatus 900 through the bidirectional power conversion device 920.

In an embodiment, the operation mode may be determined to be at least one of a plurality of preset modes. For example, the plurality of preset modes may include the first to fourth mode. Further, for example, the plurality of preset modes may further include a mode subdivided from at least one of the first to fourth modes. As an example, the first mode for charging the battery 930 using at least a portion of power generated by the PV module 910 may include a plurality of sub-modes that are subdivided according to an amount of power to be supplied to the battery 930.

In an embodiment, an operation mode corresponding to the PV power generation apparatus 900 at a predetermined point in time may be determined to include the first and second modes. In this case, when there is sufficient power generated by the PV power generation apparatus 900 at the predetermined point of time, a portion of power generated by the PV module 910 may be supplied to an outside of the PV power generation apparatus 900, and at the same time, the battery 930 may be charged using at least another portion of the power generated by the PV module 910.

In another embodiment, the operation mode corresponding to the PV power generation apparatus 900 at a predetermined point in time may be determined to include the first and fourth modes. In this case, when it is necessary to charge the battery 930 at a predetermined point in time, the battery 930 may be charged using at least a portion of power generated by the PV module 910, and at the same time, the battery 930 may be charged using power supplied from the outside of the PV power generation apparatus 900 through the bidirectional power conversion device 920.

In yet another embodiment, the operation mode corresponding to the PV power generation apparatus 900 at a predetermined point in time may be determined to include the second and third modes. In this case, when there is insufficient power generated by the PV power generation apparatus 900 at a predetermined point in time, at least a portion of the power generated by the PV module 910 may be supplied to the outside of the PV power generation apparatus 900 through the bidirectional power conversion device 920, and at the same time, charged power stored in the battery 930 may be supplied to the outside of the PV power generation apparatus 900 through the bidirectional power conversion device 920.

In an embodiment, the bidirectional power conversion device 920 and the battery controller 940 may operate based on a determined operation mode. For example, at least one of the bidirectional power conversion device 920 and the battery controller 940 may output current in a predetermined direction based on the determined operation mode.

In an embodiment, when the operation mode is determined to include the first mode and exclude the second mode, the battery controller 940 may output current in a direction toward the battery 930 with one-side voltage set as a voltage of the battery 930 and the other-side voltage set as a voltage of the PV module 910.

In this case, the voltage of the PV module 910 may correspond to a driving point determined by the battery controller 940 based on a maximum power point tracking (MPPT) algorithm. In an embodiment, the battery controller 940 may use an MPPT algorithm to track a maximum power point for extracting maximum power from the PV module 910. For example, an input to the MPPT algorithm may include a voltage, a current, and a temperature of the PV module 910 collected at a previous point in time. In addition, an operating point determined based on the MPPT algorithm may represent a maximum power point derived from an output from the MPPT algorithm.

On the other hand, in order to track the maximum power point, the battery controller 940 may collect in real time power generation state information, such as a voltage, a current, and a temperature of the PV module 910 through at least one sensor provided in the PV module 910 and/or the battery controller 940.

In this case, the battery controller 940 may output current in a direction toward the battery 930 with one-side voltage set as a voltage of the battery 930 and the other-side voltage set as a voltage of the PV module 910.

In another embodiment, when the operation mode is determined to include the first and second modes, the battery controller 940 may output current in a direction toward the battery 930 with one-side voltage set as a voltage of the battery 930 and the other-side voltage set as a voltage of the PV module 910.

In this case, the voltage of the PV module 910 may correspond to an operating point determined by the bidirectional power conversion device 920 based on the MPPT algorithm. In an embodiment, the bidirectional power conversion device 920 may use the MPPT algorithm to track a maximum power point for extracting maximum power from the PV module 910. For example, an input to the MPPT algorithm may include a voltage, a current, and a temperature of the PV module 910 collected at a previous point in time. In addition, an operating point determined based on the MPPT algorithm may represent a maximum power point derived from an output from the MPPT algorithm.

On the other hand, in order to track the maximum power point, the bidirectional power conversion device 920 may collect in real time power generation state information, such as a voltage, a current and a temperature, of the PV module 910 through at least one sensor provided in the PV module 910 and/or bidirectional power conversion device 920.

In this case, a voltage of the PV module 910 may be determined by the bidirectional power conversion device 920, so that the battery controller 940 can actively control output current without actively changing an external voltage.

In an embodiment, when the operation mode is determined to include the second and third modes, the battery controller 940 may output current in a direction toward the bidirectional power conversion device 920 with one-side voltage set as a voltage of the battery 930 and the other-side voltage set as a voltage of the PV module 910. That is, when the operation mode is determined to include the second and third modes, the battery controller 940 may actively control output current without actively changing an external voltage.

For example, the voltage of the PV module 910 may be a specific value in the range of 30 V to 40 V under sunny weather conditions, and the voltage of the battery 930 may be 10 V. In this case, the battery controller 940 may output current in a direction toward the bidirectional power conversion device 920 with the voltage of the battery 930 being set to 10 V and the voltage of a connection point being set to a specific value within the range of 30 V to 40 V.

In this case, the voltage of the PV module 910 may correspond to an operating point determined by the bidirectional power conversion device 920 based on the MPPT algorithm. In an embodiment, the bidirectional power conversion device 920 may use the MPPT algorithm to track a maximum power point for extracting maximum power from the PV module 910. For example, an input to the MPPT algorithm may include a voltage, a current, and a temperature of the PV module 910 collected at a previous point in time. In addition, an operating point determined based on the MPPT algorithm may represent a maximum power point derived from an output from the MPPT algorithm.

That is, when the voltage of the PV module 910 is determined by the bidirectional power conversion device 920, the battery controller 940 may control discharging of the battery 930 according to the determined voltage of the PV module 910, and an additional power conversion device may not be provided between the battery controller 940 and the bidirectional power conversion device 920, so the PV power generation apparatus 900 including the battery 930 may be provided with minimal design modifications.

In another embodiment, when the operation mode is determined to include the third mode without the second mode, the battery controller 940 may output a current in a direction toward the bidirectional power conversion device 920 with one-side voltage being set to a voltage of the battery 930 and the other-side voltage being set to a predetermined voltage. That is, when the operation mode is determined to exclude the second mode and include the third mode, although the PV module 910 is not supplying generated power, the battery controller 940 may actively control the voltage of the connection point and the output current in the same manner as when the PV module 910 is in an operating state.

For example, if a voltage of the connection point is not applied by the PV module 910 due to cloudy weather conditions, the battery controller 940 may output current in a direction toward the bidirectional power conversion device 920 with the voltage of the battery 930 being set to 10V and the voltage of the connection point being set to a predetermined voltage. In this case, when the voltage of the PV module 910 under sunny weather conditions represents a range of 30 V to 40 V, the predetermined voltage may be set to a specific value within the range of 30 V to 40 V.

Furthermore, in all scenarios except for a scenario where the voltage of the PV module 910 is not present and the battery 930 needs to be discharged, the battery controller 940 may control only a direction and magnitude of current according to voltages at both sides of the battery controller 940, instead of using a predetermined voltage value.

In this case, although power generated by the PV module 910 is not present, the battery controller 940 may control the voltage of the connection point and an output current in the same manner as when the PV module 910 is in an operating state, and therefore, the PV power generation apparatus 900 including the battery 930 may be provided with minimal design modifications.

In addition, due to the voltage setting and current control of the battery controller 940, a separate power conversion device may not be provided between the PV module 910 and the bidirectional power conversion device 920, and between the battery controller 940 and the bidirectional power conversion device 920, so efficient power supply may be implemented.

Hereinafter, a detailed procedure of determining an operation mode by a management device will be described with reference to FIG. 7 and the like.

FIG. 7 is an exemplary drawing illustrating a management device for determining an operation mode according to an embodiment.

In an embodiment, a power supply system may include a management device 1010 for determining an operation mode. For example, the management device 1010 may be implemented as at least one device connected via a power line to a PV power generation apparatus 1020a or 1020b, such as the combiner 13 or the distribution device 15 as shown in FIG. 1. In another example, unlike the example shown in FIG. 7, the management device 1010 may be implemented as at least one computing device not connected via a power line to the PV power generation apparatus 1020a or 1020b.

In an embodiment, the management device 1010 may determine an operation mode based on state information for at least a portion of the power supply system. For example, the state information may include power generation state information of a PV module and battery state information of a battery.

For example, the management device 1010 may determine an operation mode based on state information for a plurality of PV power generation apparatuses 1020a and 1020b. As an example, the management device 1010 may determine a first operation mode corresponding to a first PV power generation apparatus 1020a based on state information of the first PV power generation apparatus 1020a, and determine a second operation mode corresponding to a second PV power generation apparatus 1020b based on state information of the second PV power generation apparatus 1020b.

Thereafter, a first bidirectional power conversion device 1021a connecting the first PV power generation apparatus 1020a and the management device 1010, and a first battery controller 1022a connected to the first bidirectional power conversion device 1021a may operate based on the first operation mode. In addition, a second bidirectional power conversion device 1021b connecting a second PV power generation apparatus 1020b and the management device 1010, and a second battery controller 1022b connected to the second bidirectional power conversion device 1021b may operate based on the second operation mode.

In an embodiment, the management device 1010 may determine an operation mode for each of the respective PV power generation apparatuses 1020a and 1020b to include at least one of: a first mode for supplying power from a PV module to a battery; a second mode for supplying power from a PV module to a bidirectional power conversion device; a third mode for supplying power from a battery to a bidirectional power conversion device; and a fourth mode for supplying power from a bidirectional power conversion device to a battery.

For example, when state information of the first PV power generation apparatus 1020a indicates that there is insufficient charged power of a battery included in the first PV power generation apparatus 1020a, the management device 1010 may determine the first operation mode corresponding to the first PV power generation apparatus 1020a to include the second mode and exclude the third mode, and when state information of the second PV power generation apparatus 1020b indicates that there is sufficient charged power of a battery included in the second PV power generation apparatus 1020b, the management device 1010 may determine the second operation mode corresponding to the second PV power generation apparatus 1020b to include the second and third modes.

In an embodiment, the state information may include at least one of a time, a weather condition, a load state of a load, or a power grid state of a grid, in addition to power generation state information of the PV module and battery state information of the battery.

For example, the state information may further include a time, a weather condition, and the like, and the management device 1010 may change or not change an operation mode by determining whether such power generation state information is temporary or persistent when there is insufficient generated power based on the power generation state information.

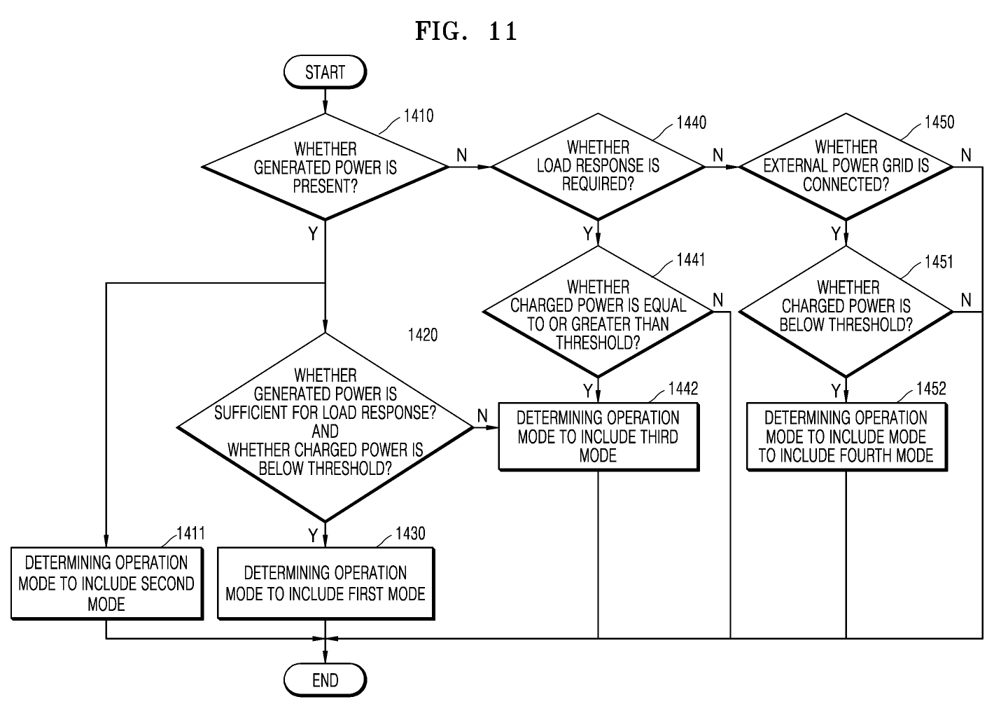

In addition, for example, the state information may further include a load state, a power grid state, and the like. On the other hand, a detailed example of a procedure of determining an operation mode by the management device 1010 based on state information including a load state and a power grid state will be described with reference to FIG. 11.

FIG. 8 is an exemplary drawing illustrating a procedure of performing communication between a management device, a bidirectional power conversion device, and a battery controller according to an embodiment.

Referring to FIG. 8, a management device 1110 may perform communication with a bidirectional power conversion device 1121 via a first communication path 1131, and the bidirectional power conversion device 1121 may perform communication with a battery controller 1122 via a second communication path 1132.

In an embodiment, the battery controller 1122 may transmit battery state information to the bidirectional power conversion device 1121. For example, the battery controller 1122 may transmit the battery state information to the bidirectional power conversion device 1121 via the second communication path 1132.

In an embodiment, the second communication path 1132 may be implemented based on a controller area network (CAN), a power line communication (PLC), or wireless communication. For example, the second communication path 1132 may be implemented as a separate communication line separate from the power line, or as a power line connecting the bidirectional power conversion device 1121 and the battery controller 1122, or may be implemented in a wireless manner.

As an example, each of the battery controller 1122 and the bidirectional power conversion device 1121 may include a communication module to implement the second communication path 1132, and the battery controller 1122 may transmit battery state information, which is collected via a battery management system (BMS), to the bidirectional power conversion device 1121.

Further, in an embodiment, the bidirectional power conversion device 1121 may transmit power generation state information of a PV module 1124 and battery state information, which is obtained from the battery controller 1122, to the management device 1110. For example, the bidirectional power conversion device 1121 may transmit power generation state information of the PV module 1124 and battery state information, obtained from the battery controller 1122, to the management device 1110 via the first communication path 1131. In an embodiment, the first communication path 1131 may be implemented based on a CAN, a PLC, or wireless communication.

As an example, each of the bidirectional power conversion device 1121 and the management device 1110 may include a communication module to implement the first communication path 1131, and the bidirectional power conversion device 1121 may transmit, to the bidirectional power conversion device 1121, power generation state information collected through at least one sensor provided in the PV module 1124 and/or the bidirectional power conversion device 1121 and battery state information obtained from the battery controller 1122.

Thereafter, the management device 1110 may obtain state information corresponding to a PV power generation apparatus 1120 from the bidirectional power conversion device 1121 and determine an operation mode corresponding to the PV power generation apparatus 1120 based on the state information.

For example, referring also to FIG. 7, the management device 1110 may obtain, from a plurality of bidirectional power conversion devices 1021a and 1021b, state information corresponding to each of the plurality of bidirectional power conversion devices 1021a and 1021b, and determine an operation mode corresponding to each of the plurality of bidirectional power conversion devices 1021a and 1021b based on the state information.

In other words, the management device 1110 may determine the first operation mode corresponding to the first PV power generation apparatus 1020a based on state information corresponding to the first PV power generation apparatus 1020a, the state information being obtained from the first bidirectional power conversion device 1021a, and determine the second operation mode corresponding to the second PV power generation apparatus 1020b based on state information corresponding to the second PV power generation apparatus 1020b, the state information being obtained from the second bidirectional power conversion device 1021b.

Referring back to FIG. 8, the bidirectional power conversion device 1121 operates based on first operation data obtained from the management device 1110, and the battery controller 1122 may operate based on second operation data obtained from the bidirectional power conversion device 1121. In the present disclosure, the first operation data represents data indicating the operation of the bidirectional power conversion device 1121, and the second operation data represents data indicating the operation of the battery controller 1122.

For example, the bidirectional power conversion device 1121 may operate based on the first operation data obtained from the management device 1110 via the first communication path 1131, and the battery controller 1122 may operate based on the second operation data obtained from the bidirectional power conversion device 1121 via the second operation path 1132.

In an embodiment, the management device 1110 may determine an operation mode and generate the first operation data based on the determined operation mode. For example, based on the determined operation mode, the management device 1110 may generate the first operation data indicating a direction and a magnitude of current to be output by the bidirectional power conversion device 1121.

On the other hand, the second operation data may be generated based on an operation mode determined, and the second operation data may be generated directly by the management device 1110 or may be generated by the bidirectional power conversion device 1121 based on an operation mode determined by the management device 1110. For example, depending on the determined operation mode, the management device 1110 or the bidirectional power conversion device 1121 may generate the second operation data indicating a direction and magnitude of current to be output from the battery controller 1122.

Hereinafter, detailed examples of a procedure of operation of the management device 1110 will be described with reference to FIGS. 8-11.

FIG. 9 shows an example of an operation method of a management device.

Referring to FIG. 9, at step 1210, the management device 1110 may obtain state information from at least one bidirectional power conversion device 1121.

In an embodiment, the management device 1110 may obtain state information including power generation state information and battery state information through a communication path 1131 or 1132. For example, the management device 1110 may obtain, from a plurality of bidirectional power conversion device 1121, state information corresponding to each of the plurality of bidirectional power conversion device 1121. In addition, for example, the management device 1110 may obtain state information that further includes at least one of: a time, a weather condition, a load state of a load, and a grid state of a grid.

At step 1220, the management device 1110 may determine an operation mode corresponding to each of the at least one bidirectional power conversion device 1121 based on the state information.

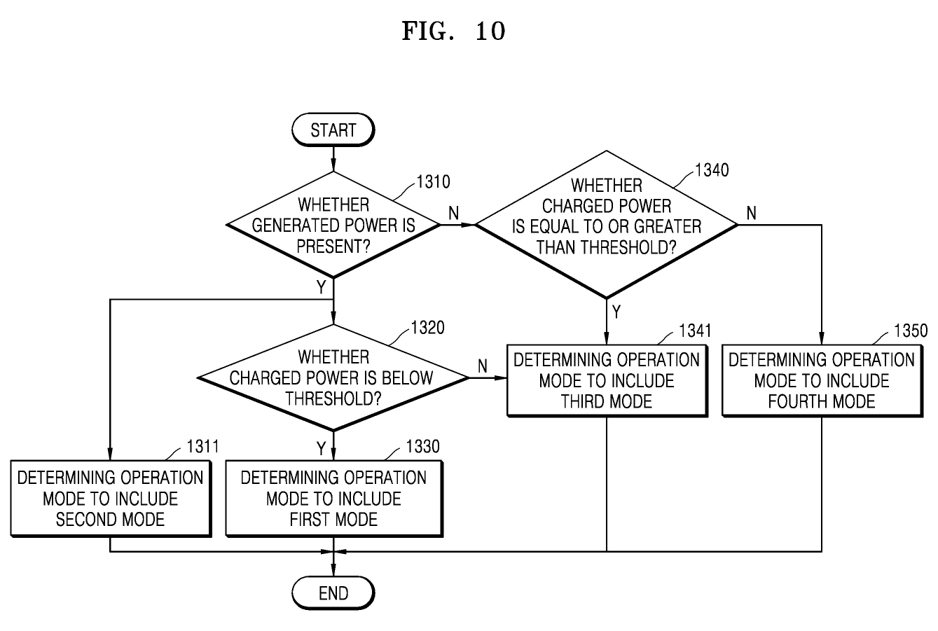

An example of a detailed procedure of determining an operation mode by the management device 1110 based on state information including power generation state information and battery state information will be described with reference to FIG. 10. An example of a detailed procedure of determining an operation mode by the management device 1110 based on state information including power generation state information, battery state information, a load state, and grid state will be described with reference to FIG. 11.

At step 1230, the management device 1110 may generate first operation data corresponding to each of the at least one bidirectional power conversion device 1121 based on the operation mode. In an embodiment, the management device 1110 may generate first operation data indicating a direction and magnitude of current to be output by each of the at least one bidirectional power conversion device 1121 according to a determined operation mode.

The operation mode may be determined for each of the at least one bidirectional power conversion device 1121, and the management device 1110 may generate the first operation data corresponding to each of the at least one bidirectional power conversion device 1121.

FIG. 10 is an example of a procedure of determining an operation mode according to an embodiment.

The operation mode determination procedure as shown in FIG. 10 is an example of a procedure of determining an operation mode including at least one of first to fourth modes, described above with reference to FIG. 6, based on state information including power generation state information and battery state information. Meanwhile, a method in which the management device 1110 utilizes the state information including the power generation state information and battery state information in determining an operation mode is not limited to the example shown in FIG. 10.

Referring to FIG. 10, at step 1310, the management device 1110 may determine whether generated power is present. For example, the management device 1110 may determine whether power generated by the PV module 1124 is present, based on power generation state information obtained from the bidirectional power conversion device 1121.

Based on a result of the determination at step 1310 indicating that generated power is present, the management device 1110 may perform steps 1311 and 1320, and based on a result of the determination at step 1310 indicating that generated power is not present, the management device 1110 may perform step 1340.

At step 1311, the management device 1110 may determine the operation mode to include a second mode. That is, when the generated power is present, the management device 1110 may determine the operation mode to include the second mode.

At step 1320, the management device 1110 may determine whether charged power is below a threshold. For example, the management device 1110 may determine whether charged power stored in a battery 1123 is below the threshold based on the battery state information obtained from the bidirectional power conversion device 1121. In this case, the threshold for charged power may be set in consideration of a charge level required for a stable operation of the battery 1123.

Based on a result of the determination at step 1320 indicating that the charged power is below the threshold, the management device 1110 may perform step 1330, and based on the determination results at step 1320 indicating that the charged power is equal to or greater than the threshold, the management device 1110 may perform step 1341.

At step 1330, the management device 1110 may determine the operation mode to include a first mode. That is, when the charged power of the battery 1123 is insufficient, the management device 1110 may determine the operation mode to include the first mode.

Thus, when the power generated by the PV module 1124 is present and the charged power of the battery 1123 is below a threshold, the management device 1110 may determine the operation mode to include the first and second modes, and when the power generated by the PV module 1124 is present and the charged power of the battery 1123 is equal to or greater than the threshold, the management device 1110 may determine the operation mode to include the second and third modes.

Meanwhile, at step 1340, the management device 1110 may determine whether the charged power is equal to or greater than the threshold. For example, based on battery state information obtained from the bidirectional power conversion device 1121, the management device 1110 may determine whether the charged power stored in the battery 1123 is equal to or greater than the threshold . In this case, the threshold for charged power may be set in consideration of a charge level required for a stable operation of the battery 1123.

Based on a result of the determination at step 1340 indicating that the charged power is equal to or greater than the threshold, the management device 1110 may perform step 1341, and based on a result of the determination at step 1340 indicating that the charged power is below the threshold, the management device 1110 may perform step 1350.

At step 1341, the management device 1110 may determine the operation mode to include a third mode. That is, when the charged power of the battery 1123 is sufficient, the management device 1110 may determine the operation mode to include the third mode.

At step 1350, the management device 1110 may determine the operation mode to include the fourth mode. That is, when the charged power of the battery 1123 is insufficient, the management device 1110 may determine the operation mode to include the fourth mode.

Meanwhile, a procedure of determining an operation mode shown in FIG. 10 may be performed repeatedly according to a preset condition. For example, the management device 1110 may update the operation mode in real time based on state information that is updated at a predetermined interval.

FIG. 11 is an example of a procedure of determining an operation mode according to another embodiment.

The procedure of determining an operation mode as shown in FIG. 11 is an example of a procedure of determining an operation mode including at least one of first to fourth modes, described above with reference to FIG. 6, based on state information including power generation state information, battery state information, a load state, and a power grid state. Meanwhile, a method in which the management device 1110 utilizes the state information including power generation state information, battery state information, a load state, and a power grid state in determining an operation mode is not limited to the example shown in FIG. 11.

Referring to FIG. 11, at step 1410, the management device 1110 may determine whether generated power is present. For example, the management device 1110 may determine whether power generated by the PV module 1124 is present, based on power generation state information obtained from the bidirectional power conversion device 1121.

Based on a result of the determination at step 1410 indicating that the generated power is present, the management device 1110 may perform operations 1411 and 1420, and based on a result of the determination at step 1410 indicating that the generated power is not present, the management device 1110 may perform operation 1440.

At step 1411, the management device 1110 may determine the operation mode to include a second mode. That is, when the generated power is present, the management device 1110 may determine the operation mode to include the second mode.

At step 1420, the management device 1110 may determine whether the generated power is sufficient for load response and whether the charged power is below the threshold. For example, based on a load state, the management device 1110 may determine whether the power generated by the PV module 1124 is by itself sufficient enough for load response. In addition, based on the battery state information obtained from the bidirectional power conversion device 1121, the management device 1110 may determine whether the charged power stored in the battery 1123 is below the threshold. In this case, the threshold for charged power may be set in consideration of a charge level required for a stable operation of the battery 1123.

Based on a result of the determination at step 1420 indicating that the generated power is sufficient for load response and that the power charging is below the threshold, the management device 1110 may perform step 1430. On the other hand, based on a result of the determination at step 1420 indicating that the generated power is insufficient for load response or that the power charging is equal to or greater than the threshold, the management device 1110 may perform step 1442.

At step 1430, the management device 1110 may determine the operation mode to include a first mode. That is, when the power generated by the PV module 1124 is sufficient for load response while the charged power of the battery 1123 is insufficient, the management device 1110 may determine the operation mode to include the first mode.

Thus, when the power generated by the PV module 1124 is sufficient for load response and the charged power of the battery 1123 is below a threshold, the management device 1110 may determine the operation mode to include the first and second modes. On the other hand, when the power generated by the PV module 1124 is present but the power is by itself insufficient for load response or the charged power of the battery 1123 is equal to or greater than the threshold, the management device 1110 may determine the operation mode to include the second and third modes.

Meanwhile, in a case where the battery 1123 is dischargeable unlike the example shown in FIG. 11, the management device 1110 may determine the operation mode to include the third mode, regardless of whether the generated power is sufficient for load response and/or whether the charged power of the battery 1123 is below the threshold. Thus, when the power generated by the PV module 1124 is not present or the power generated by the PV module 1124 is by itself insufficient for load response, the PV power generation apparatus 1120 may supply power stored in the battery 1123 to the outside.

At step 1440, the management device 1110 may determine whether load response is required. For example, based on a load state, the management device 1110 may determine whether load response is required for at least one load connected to the PV power generation apparatus 1120.

Based on a result of the determination at step 1440 indicating that load response is required, the management device 1110 may perform step 1441, and based on a result of the determination at step 1440 indicating that load response is not required, the management device 1110 may perform step 1450.

At step 1441, the management device 1110 may determine whether the charged power is equal to or greater than the threshold. For example, based on battery state information obtained from the bidirectional power conversion device 1121, the management device 1110 may determine whether the charged power stored in the battery 1123 is equal to or greater than the threshold. In this case, the threshold for charged power may be set in consideration of a charge level required for a stable operation of the battery 1123.

Based on a result of the determination at step 1441 indicating that the charged power is equal to or greater than the threshold, the management device 1110 may perform step 1442.

At step 1442, the management device 1110 may determine the operation mode to include a third mode. That is, when the charged power of the battery 1123 is sufficient, the management device 1110 may determine the operation mode to include the third mode.

At step 1450, the management device 1110 may determine whether an external grid is connected. For example, the management device 1110 may determine whether the external grid is connected or not connected to the PV power generation apparatus 1120 based on a power grid state (e.g., off-grid condition, etc.).

Based on a result of the determination at step 1450 indicating that the external grid is connected, the management device 1110 may perform step 1451.

At step 1451, the management device 1110 may determine whether the charged power is below the threshold. For example, based on battery state information obtained from the bidirectional power conversion device 1121, the management device 1110 may determine whether charged power stored in the battery 1123 is below the threshold. In this case, the threshold for charged power may be set in consideration of a charge level required for a stable operation of the battery 1123.

Based on a result of the determination at step 1451 indicating that the charged power is below the threshold, the management device 1110 may perform step 1452.

At step 1452, the management device 1110 may determine the operation mode to include a fourth mode. That is, when the charged power of the battery 1123 is insufficient, the management device 1110 may determine the operation mode to include the fourth mode.

In an embodiment, whether the external grid is connected or not may be considered prior to the procedure of determining an operation mode. For example, the management device 1110 may determine whether the external grid is connected, and determine an operation mode based on a result of the determination indicating that the external grid is connected, via the procedure shown in FIG. 11. In this case, the management device 1110 may omit the determination at step 1450. In other words, the management device 1110 may perform step 1451 without step 1450, based on a result of the determination at step 1440 indicating that load response is not required.

Thus, when the external grid is connected, the management device 1110 may determine an operation mode to include at least one of a plurality of modes including the first, second, third, and fourth modes.

In addition, for example, the management device 1110 may determine whether the external grid is connected, and determine the operation mode based on a result of the determination indicating that the external grid is not connected, via the operation mode determination procedure of FIG. 11 with the exception of steps 1450, 1451, and 1452.

Thus, when the external grid is not connected, the management device 1110 may determine an operation mode to include at least one of a plurality of modes including the first, second, and third modes, excluding the fourth mode.

Meanwhile, the operation mode determination procedure shown in FIG. 11 may be performed repeatedly according to a preset condition. For example, the management device 1110 may update the operation mode in real time based on state information that is updated at a predetermined interval.

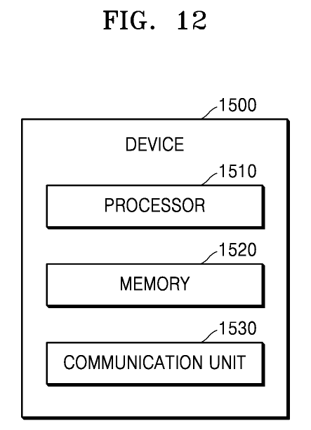

FIG. 12 is a block diagram illustrating a management device according to an embodiment. A device 1500 shown in FIG. 12 may correspond to the management device 1110 shown in FIG. 8.

Referring to FIG. 12, the device 1500 may include a processor 1510, a memory 1520, and a communication unit 1530. The device 1500 shown in FIG. 12 shows only the components related to the embodiment. Therefore, it may be understood by those skilled in the art that other general-purpose components may be included in addition to the components shown in FIG. 12.

The processor 1510 may control the overall operation of the device 1500. For example, the processor 1510 may control the overall operation of the memory 1520, the communication unit 1530, an input unit (not shown), and/or an output unit (not shown) by executing programs stored in the memory 1520. The processor 1510 may control the operation of the device 1500 by executing the programs stored in memory 1520.

The processor 1510 may control at least one operation of the device 1500 described above with reference to FIGS. 7-11. For example, the processor 1510 may control the communication unit 1530 to obtain state information from at least one bidirectional power conversion device, may determine an operation mode corresponding to each of the at least one bidirectional power conversion device based on state information, and may generate first operation data corresponding to each of the at least one bidirectional power conversion device based on the determined operation mode.

Detailed examples of the operation of the processor 1510 are the same as described above with reference to FIGS. 7-11. Therefore, the detailed description of the operation of the processor 1510 is hereinafter omitted.

The processor 1510 may be implemented using the at least one of application specific integrated circuits (ASICs), a digital signal processors (DSPs), digital signal processing devices (DSPDs), programmable logic devices (PLDs), field programmable gate arrays (FPGAs), controllers, micro-controllers, micro-processors, and electronic units for performing other functions.

The memory 1520, as a hardware component for storing data processed by the device 1500, may store programs for operations, processing, and control of the processor 1510.

The memory 1520 may include a random access memory (RAM) such as a dynamic RAM (DRAM) or a static RAM (SRAM), a read-only memory (ROM), an electrically erasable programmable ROM (EEPROM), a CD-ROM, a Blu-ray or other optical disk storage, a hard disk drive (HDD), a solid state drive (SSD), or a flash memory.

The communication unit 1530 may include at least one component that allows the device 1500 to perform wired/wireless communication with at least a portion of the power supply system (e.g., the power supply system 10) shown in FIG. 1, and/or with other external devices. For example, the communication unit 1530 may include a short-range communication unit, and/or a mobile communication unit, etc.

The above-described embodiment of the present disclosure may be implemented in the form of a computer program executable through various components on a computer, and such a computer program may be recorded on a computer-readable medium. In this case, the medium may include, but are not limited to, magnetic media such as a hard disk, a floppy disk, and a magnetic tape; optical media such as a compact disc read-only memory (CD-ROM) and a digital versatile disk (DVD); magneto-optical media such as a floptical disk; and hardware devices specially configured to store and execute program instructions, such as a read-only memory (ROM), a random access memory (RAM), and a flash memory.

Meanwhile, the computer program may be specially designed and configured for the present disclosure or may be publicly known to and available by those skilled in the computer software field. Examples of the computer program include machine language codes generated by a compiler as well as high-level language codes that are executable by a computer using an interpreter or the like.

According to an embodiment, a method according to various embodiments of the present disclosure may be included and provided in a computer program product. The computer program product may be traded as a product between a seller and a buyer. The computer program product may be distributed in the form of a machine-readable storage medium (e.g., a compact disc read only memory (CD-ROM)), or may be distributed (e.g., downloaded or uploaded) online via an application store (e.g., PlayStore™), or between two user devices (e.g., smart phones) directly. If distributed online, at least a portion of the computer program product may be temporarily generated or at least temporarily stored in the machine-readable storage medium, such as memory of the manufacturer's server, a server of the application store, or a relay server.

According to the present disclosure, a battery may be provided for each PV module, implementing efficient space design and providing a PV power generation apparatus including a battery with minimal design modifications.

According to the present disclosure, an operation mode may be determined based on state information, facilitating an efficient power supply optimized for a state of the power supply system.

The effects of the embodiments are not limited to the above-mentioned effects, and other effects not mentioned will be clearly understood by those skilled in the art from the description herein.

Steps of all methods described herein can be performed in any suitable order unless otherwise indicated herein or otherwise clearly contradicted by context. The present disclosure is not limited to the described order of the steps. The use of any and all examples, or exemplary terms (e.g., “such as”) provided herein, is intended merely to better illuminate the present disclosure and does not pose a limitation on the scope of the present disclosure unless otherwise claimed. Also, numerous modifications and adaptations will be readily apparent to one of ordinary skill in the art without departing from the spirit and scope of the present disclosure.

It should be noted that the spirit of the present disclosure is not limited to the embodiments described above, and not only the claims to be described below, but also all ranges equivalent to or equivalently changed from the claims fall within the scope of the spirit of the present disclosure.

What is claimed is:

1. A photovoltaic (PV) power generation apparatus comprising:
a PV module;
a bidirectional power conversion device connected via a power line to the PV module;
a battery configured to store power supplied from at least one of the PV module and the bidirectional power conversion device and supply the stored power to the bidirectional power conversion device; and
a battery controller connected between a connection point located on the power line and the battery,
wherein the bidirectional power conversion device and the battery controller operate based on an operation mode, and
wherein the operation mode is determined based on state information including power generation state information of the PV module and battery state information of the battery.

2. The PV power generation apparatus of claim 1, wherein the bidirectional power conversion device, the battery, and the battery controller are provided at a rear side of the PV module.

3. The PV power generation apparatus of claim 1, wherein the operation mode is determined to be at least one of a plurality of preset modes comprising: a first mode for supplying power from the PV module to the battery, a second mode for supplying power from the PV module to the bidirectional power conversion device, a third mode for supplying power from the battery to the bidirectional power conversion device; and a fourth mode for supplying power from the bidirectional power conversion device to the battery.

4. The PV power generation apparatus of claim 3, wherein:
based on the operation mode being determined to include the second mode and the third mode, the battery controller outputs current to the bidirectional power conversion device with one-side voltage being set to a voltage of the battery and the other-side voltage being set to a voltage of the PV module, and
based on the operation mode determined to exclude the second mode and include the third mode, the battery controller outputs current to the bidirectional power conversion device with the one-side voltage being set to a voltage of the battery and the other-side voltage being set to a predetermined voltage.

5. The PV power generation apparatus of claim 4, wherein a voltage of the PV module corresponds to an operating point determined by the bidirectional power conversion device based on a maximum power point tracking (MPPT) algorithm.

6. The PV power generation apparatus of claim 1, wherein:
the bidirectional power conversion device operates based on first operation data obtained from a management device,
the battery controller operates based on second operation data generated based on an operation mode and obtained from the bidirectional power conversion device, and
the management device determines the operation mode and generates the first operation data based on the operation mode.

7. The PV power generation apparatus of claim 6, wherein:
the battery controller transmits the battery state information to the bidirectional power conversion device, and
the bidirectional power conversion device transmits the power generation state information and the battery state information to the management device.

8. The PV power generation apparatus of claim 7, wherein the management device obtains, from a plurality of bidirectional power conversion devices comprising the bidirectional power conversion device, state information corresponding to each of the plurality of bidirectional power conversion devices, and determines an operation mode corresponding to each of the plurality of bidirectional power conversion devices based on the state information.

9. The PV power generation apparatus of claim 1, wherein the state information further comprises at least one of: a time; a weather condition; a load state of a load connected to the bidirectional power conversion device; and a power grid state of a grid connected to the bidirectional power conversion device.

10. The PV power generation apparatus of claim 1, further comprising:
a current direction control element provided between the PV module and the connecting point and configured to limit current flowing toward the PV module.

11. A device for managing operation of a photovoltaic (PV) power generation apparatus, comprising:
a communication unit configured to perform communication;
a memory having at least one program stored therein; and
a processor configured to operate by executing at least one program;
wherein the processor controls the communication unit to obtain state information from a bidirectional power conversion device corresponding to each of at least one PV power generation apparatus, and determines an operation mode corresponding to each of the at least one PV power generation apparatus based on the state information.

12. The device of claim 11, wherein each of the at least one PV power generation apparatus comprises:
a bidirectional power conversion device;
a PV module connected via a power line to the bidirectional power conversion device;
a battery configured to store power supplied from at least one of the PV module and the bidirectional power conversion device and supply the stored power to the bidirectional power conversion device; and
a battery controller connected between a connection point located on the power line and the battery,
wherein the bidirectional power conversion device and the battery controller operate based on the operation mode.

13. The device of claim 12, wherein the state information comprises power generation state information of the PV module and battery state information of the battery.

14. The device of claim 13, wherein:
the processor controls the communication module to obtain the power generation state information and the battery state information from the bidirectional power conversion device, and
the battery state information is obtained by the bidirectional power conversion device from the battery controller.

15. The device of claim 13, wherein the state information further comprises at least one of: a time; a weather condition; a load state of a load connected to the bidirectional power conversion device; and a power grid state of a grid connected to the bidirectional power conversion device.

16. The device of claim 12, wherein the processor determines the operation mode to be at least one of a plurality of preset modes comprising: a first mode for supplying power from the PV module to the battery, a second mode for supplying power from the PV module to the bidirectional power conversion device, a third mode for supplying power from the battery to the bidirectional power conversion device; and a fourth mode for supplying power from the bidirectional power conversion device to the battery.

17. The device of claim 12, wherein:
the processor generates first operation data based on the operation mode and controls the communication unit to transmit the first operation data to the bidirectional power conversion device,
the bidirectional power conversion device operates based on the first operation data and transmits second operation data generated based on the operation mode to the battery controller, and
the battery controller operates based on the second operation data.

18. A method for managing operation of a photovoltaic (PV) power generation apparatus, comprising:
obtaining state information from a bidirectional power conversion device corresponding to each of at least one PV power generation apparatus; and
determining an operation mode corresponding to each of the at least one PV power generation apparatus based on the state information.
